(19) United States
(12) Patent Application Publication
(10) Pub. No.: US 2011/0080380 A1
(43) Pub. Date: Apr. 7, 2011

(54) PLASMA DISPLAY DEVICE AND METHOD FOR DRIVING PLASMA DISPLAY DEVICE

(76) Inventors: Kosuke Makino, Osaka (JP); Yutaka Yoshihama, Osaka (JP)

(21) Appl. No.: 12/745,981

(22) PCT Filed: Jun. 12, 2009
(86) PCT No.: PCT/JP2009/002666

§ 371 Date: Jun. 3, 2010

(30) Foreign Application Priority Data
Jun. 13, 2008 (JP) 2008-155021

(51) Int. Cl. G09G 3/28

(52) U.S. Cl. 345/204

(57) ABSTRACT

A plasma display device has a plasma display panel, a scan electrode driving circuit, a sustain electrode driving circuit, and a data electrode driving circuit. In the sustain period of at least one subfield, the scan electrode driving circuit and the sustain electrode driving circuit apply a plurality of sustain pulses alternately to scan electrodes and sustain electrodes, and the data electrode driving circuit applies a data pulse to data electrodes by changing the timing according to the sustain pulses while the sustain pulses are applied.

THIS APPLICATION IS A U.S. NATIONAL PHASE APPLICATION OF PCT INTERNATIONAL APPLICATION PCT/JP2009/002666.

### TECHNICAL FIELD

The present invention relates to a driving method for a plasma display panel for use in a wall-mounted television or a large monitor, and to a plasma display device.

### BACKGROUND ART

A typical AC surface discharge panel used as a plasma display panel (hereinafter simply referred to as “panel”) has a large number of discharge cells that are formed between a front plate and a rear plate facing each other. The front plate has the following elements:
a plurality of display electrode pairs, each formed of a scan electrode and a sustain electrode, disposed on a front glass substrate parallel to each other; and
a dielectric layer and a protective layer formed to cover the display electrode pairs. The rear plate has the following elements:
a plurality of parallel data electrodes formed on a rear glass substrate;
a dielectric layer formed over the data electrodes so as to cover the electrodes;
a plurality of barrier ribs formed on the dielectric layer parallel to the data electrodes; and
phosphor layers formed on the surface of the dielectric layer and on the side faces of the barrier ribs. The front plate and the rear plate face each other so that the display electrode pairs and the data electrodes three-dimensionally intersect, and are sealed together. A discharge gas containing xenon in a partial pressure ratio of 10%, for example, is sealed into the inside discharge space. Discharge cells are formed in portions where the display electrode pairs face the data electrodes. In a panel having such a structure, gas discharge generates ultraviolet light in each discharge cell. This ultraviolet light excites the red, green, and blue phosphors so that the phosphors emit the corresponding colors for color display.

A subfield method is typically used as a method for driving the panel. In the subfield method, one field period is divided into a plurality of subfields, and combination of subfields of light emission provides gradation display. Each subfield has an initializing period, an address period, and a sustain period. In the initializing period, an initializing discharge is caused in each discharge cell to form wall charge necessary for the subsequent address operation on each electrode. In the address period, address discharge is caused to form wall charge selectively in the discharge cells to be lit. In the sustain period, sustain pulses are applied alternately to the display electrode pairs, each formed of a scan electrode and a sustain electrode. Thereby, a sustain discharge is caused in the discharge cells having undergone the address discharge to cause the phosphor layers of the corresponding discharge cells to emit light. In this manner, an image is displayed.

As a circuit for applying sustain pulses to the display electrode pairs, a so-called power recovery circuit capable of reducing power consumption is typically used (see Patent Literature 1, for example). In Patent Literature 1, focusing on the fact that each display electrode pair is a capacitive load having interelectrode capacitance between the display electrode pair, the inventors have disclosed a power recovery circuit. Using a resonance circuit including an inductor as a component thereof, the power recovery circuit causes LC resonance between the inductor and the interelectrode capacitance. Then, the power recovery circuit recovers the electric charge stored in the interelectrode capacitance and reuses the recovered charge to drive the display electrode pairs.

Meanwhile, with recent increases in the screen size and definition, various efforts are made to improve the emission efficiency and luminance of the panel. For example, studies are actively made for considerably enhancing the emission efficiency by increasing the xenon partial pressure. However, increasing the xenon partial pressure increases variations in the discharge timing, thus causing variations in the emission intensity in each discharge cell. This phenomenon can make display luminance non-uniform in some cases. In order to improve this non-uniform luminance, a driving method is disclosed (see Patent Literature 2, for example). This driving method makes the display luminance uniform by inserting a sustain pulse having a steep rising edge at a rate of once every plurality of times, for example, and matching the sustain discharge timings.

When, at an increased xenon partial pressure, a high-luminance image is displayed after a still image has been displayed for an extended period of time, the still image is recognized as an afterimage and the image display quality is degraded in some cases. In order to reduce such a phenomenon of persistence of vision, a method is disclosed (see Patent Literature 3, for example). This method suppresses degradation of image display quality by moving the display position of an image likely to cause an afterimage.

However, in the method disclosed in Patent Literature 3, although the recognition of an afterimage can be reduced, insertion of a sustain pulse having a steep rising edge increases the reactive power of the driving circuit and power consumption. Further, the movement of electric charge between adjacent cells becomes active at the rising timing of the steep pulse in the sustain period. This phenomenon easily causes a failure in display, i.e. false lighting of the cells to be unlit.

### Citation List

### Patent Literature]

[PTL1] Japanese Patent Examined Publication No. H07-109542

[PTL2] Japanese Patent Unexamined Publication No. 2005-338120

[PTL3] Japanese Patent Unexamined Publication No. H08-248934

### SUMMARY OF INVENTION

A plasma display device has the following elements:
a plasma display panel including:
   a first substrate having display electrode pairs in a parallel direction, each of the display electrode pairs being formed of a scan electrode and a sustain electrode; and
   a second substrate having data electrodes in a vertical direction,
   the first substrate and the second substrate being disposed so that discharge cells are formed in intersecting parts of the display electrode pairs and the data electrodes;
a scan electrode driving circuit for driving the scan electrodes;
a sustain electrode driving circuit for driving the sustain electrodes; and
a data electrode driving circuit for driving the data electrodes,
the plasma display panel being driven by a subfield method where one field is formed of a plurality of subfields.
   In the sustain period of at least one of the subfields, the scan electrode driving circuit and the sustain electrode driving circuit apply a plurality of sustain pulses alternately to the scan electrodes and the sustain electrodes, and the data electrode driving circuit applies a data pulse to the data electrodes by changing the timing according to the sustain pulses while the sustain pulses are applied.

This operation can provide high-fidelity image display, reduce a phenomenon of persistence of vision itself, and suppress the power consumption necessary for light emission of the panel.

The data electrode driving circuit applies the data pulse to the data electrodes at the timing such that the light emission of a first discharge is stronger than the light emission of a second discharge. Alternatively, the data electrode driving circuit may apply the data pulse to the data electrodes at the timing such that the light emission of the second discharge is stronger than the light emission of the first discharge.

In the plasma display device of the present invention, the timings at which the data electrode driving circuit applies the data pulse to the data electrodes may be a first predetermined timing and a second predetermined timing.

In the plasma display device of the present invention, the timing at which the data electrode driving circuit applies the data pulse to the data electrodes may be before or after the timing at which the sustain pulses applied to the scan electrodes or the sustain electrodes are clamped to a predetermined voltage.

In a driving method for a plasma display device, the plasma display device has the following elements:
a plasma display panel including:
   a first substrate having display electrode pairs, each formed of a scan electrode and a sustain electrode, in a parallel direction; and
   a second substrate having data electrodes in a vertical direction,
   the first substrate and the second substrate being disposed so that discharge cells are formed in intersecting parts of the display electrode pairs and the data electrodes;
a scan electrode driving circuit for driving the scan electrodes;
a sustain electrode driving circuit for driving the sustain electrodes; and
a data electrode driving circuit for driving the data electrodes,
the plasma display panel being driven by a subfield method where one field is formed of a plurality of subfields.
   In the sustain period of at least one of the subfields, the scan electrode driving circuit and the sustain electrode driving circuit apply sustain pulses alternately to the scan electrodes and the sustain electrodes, and the data electrode driving circuit applies a data pulse to the data electrodes by changing the timing while the sustain pulses are applied.

### BRIEF DESCRIPTION OF DRAWINGS

FIG. 1 is an exploded perspective view showing a structure of a panel in a plasma display device in accordance with an exemplary embodiment of the present invention.

FIG. 2 is an electrode array diagram of the panel.

FIG. 3 is a waveform chart of driving voltages applied to the respective electrodes of the panel.

FIG. 4 is a circuit block diagram of the plasma display device in accordance with the exemplary embodiment.

FIG. 5 is a waveform chart of driving voltages applied in a sustain period in the plasma display device in accordance with the exemplary embodiment.

FIG. 6 is a diagram showing an example of waveforms of a sustain pulse and a data pulse applied in the sustain period in the plasma display device in accordance with the exemplary embodiment.

FIG. 7 is a diagram showing another example of waveforms of a sustain pulse and a data pulse applied in the sustain period in the plasma display device in accordance with the exemplary embodiment.

FIG. 8 is a diagram showing still another example of waveforms of a sustain pulse and a data pulse applied in the sustain period in the plasma display device in accordance with the exemplary embodiment.

FIG. 9 is a driving waveform chart showing an example of an arrangement of sustain pulses in the sustain period in the plasma display device in accordance with the exemplary embodiment.

FIG. 10 is a driving waveform chart showing another example of an arrangement of sustain pulses in the sustain period in the plasma display device in accordance with the exemplary embodiment.

FIG. 11 is a circuit diagram of sustain pulse generating circuits in the plasma display device in accordance with the exemplary embodiment.

FIG. 12 is a diagram showing a circuit configuration of a data electrode driving circuit in the plasma display device in accordance with the exemplary embodiment.

### DESCRIPTION OF EMBODIMENTS

### First Exemplary Embodiment

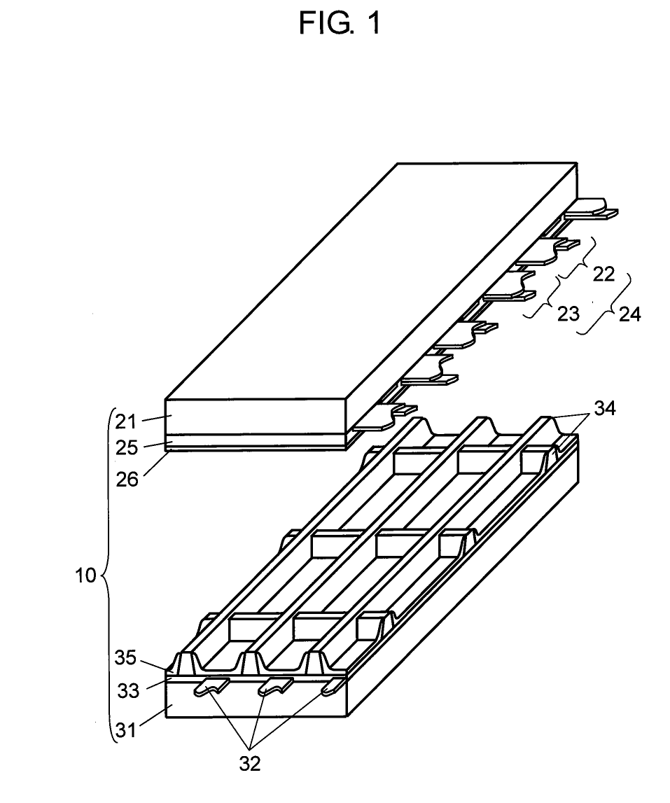

FIG. 1 is an exploded perspective view showing a structure of panel 10 in a plasma display device in accordance with the exemplary embodiment of the present invention. A plurality of display electrode pairs 24, each formed of scan electrode 22 and sustain electrode 23, are formed on glass front plate 21, i.e. a first substrate, in the horizontal direction of panel 10. Dielectric layer 25 is formed so as to cover display electrode pairs 24. Protective layer 26 is formed over dielectric layer 25. A plurality of data electrodes 32 are formed on rear plate 31, i.e. a second substrate, in the vertical direction of panel 10. Dielectric layer 33 is formed so as to cover data electrodes 32, and mesh barrier ribs 34 are formed on data electrodes 32. On the side faces of barrier ribs 34 and on the surface of dielectric layer 33, phosphor layers 35 each emitting red, green, or blue light are formed.

Front plate 21 and rear plate 31 face each other so that display electrode pairs 24 intersect with data electrodes 32 with a small discharge space sandwiched between the electrodes. The outer peripheries of these front plate 21 and rear plate 31 are sealed with a sealing material, e.g. a glass frit. A mixed gas of neon and xenon, for example, is sealed into the discharge space as a discharge gas. The discharge space is partitioned into a plurality of compartments by barrier ribs 34. Discharge cells are formed in intersecting parts of display electrode pairs 24 and data electrodes 32. The discharge cells discharge and emit light to display an image.

The structure of panel 10 is not limited to the above, and may include barrier ribs formed in a stripe pattern, for example.

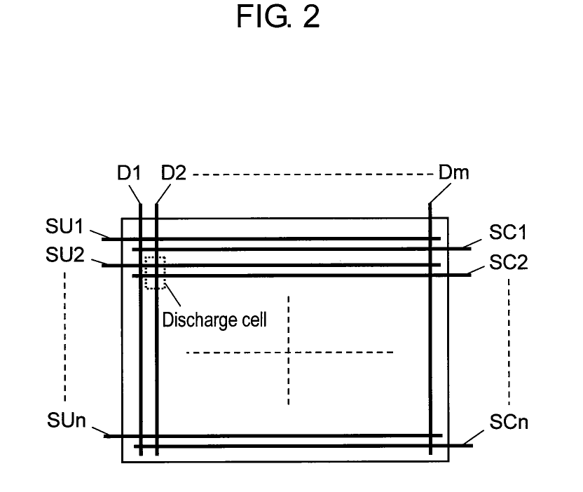

FIG. 2 is an electrode array diagram of panel 10 in accordance with the exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the row direction. Panel 10 also has m data electrode D1 through data electrode Dm (data electrodes 32 in FIG. 1) long in the column direction. A discharge cell is formed in the part where a pair of scan electrode SCi (i being 1 through n) and sustain electrode SUi (i being 1 through n) intersects with one data electrode Dj (j being 1 through m). Thus m×n discharge cells are formed in the discharge space. Incidentally, as shown in FIG. 1 and FIG. 2, scan electrode SCi and sustain electrode SUi are formed in pairs parallel to each other. For this reason, interelectrode capacitance Cp exists between scan electrode SC1 through scan electrode SCn and sustain electrode SU1 through sustain electrode SUn.

Next, driving voltage waveforms for driving panel 10 and the operation thereof are described.

A plasma display device displays gradations by a subfield method: one field period is divided into a plurality of subfields, and light emission and no light emission in each discharge cell are controlled in each subfield. Each subfield (SF) has an initializing period, an address period, and a sustain period. In the initializing period, an initializing discharge is caused in each discharge cell to form wall charge necessary for the subsequent address discharge on each electrode. In the address period, an address discharge is caused to form wall charge selectively in the discharge cells to be lit. In the sustain period, a number of sustain pulses equal in number to the luminance weight multiplied by the luminance magnification are applied alternately to display electrode pairs 24 to cause a sustain discharge in the discharge cells having undergone the address discharge.

In the exemplary embodiment, one field is divided into ten subfields (the first SF, and second SF through tenth SF), and the respective subfields have luminance weights of 1, 2, 3, 6, 11, 18, 30, 44, 60, and 80, for example. In the initializing period of the first SF, an initializing operation is performed in all the discharge cells. In the initializing periods of the second SF through the tenth SF, the initializing operation is performed selectively in the discharge cells having undergone a sustain discharge. However, in the present invention, the number of subfields and the luminance weights of the respective subfields are not limited to the above values.

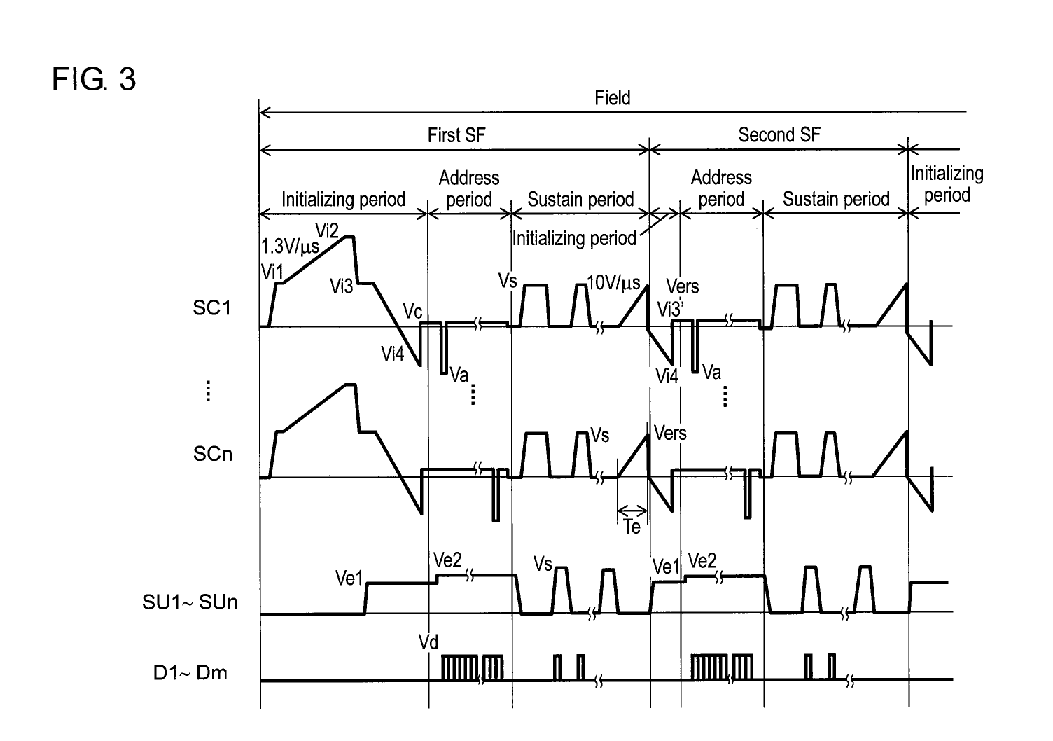

FIG. 3 is a waveform chart of driving voltages applied to the respective electrodes of panel 10 in accordance with the exemplary embodiment of the present invention. FIG. 3 shows driving voltage waveforms in two subfields. Because the driving voltage waveforms in other subfields are substantially similar, the description of those waveforms is omitted.

In the first half of the initializing period of the 1st SF, 0(V) is applied to each of data electrode D1 through data electrode Dm and sustain electrode SU1 through sustain electrode SUn, and an up-ramp waveform voltage is applied to scan electrode SC1 through scan electrode SCn. Here, the up-ramp waveform voltage gradually rises from voltage Vi1, which is equal to or lower than a breakdown voltage, toward voltage Vi2, which exceeds the breakdown voltage with respect to sustain electrode SU1 through sustain electrode SUn. While this up-ramp voltage is rising, a weak initializing discharge occurs between scan electrode SC1 through scan electrode SCn and sustain electrode SU1 through sustain electrode SUn, and between scan electrode SC1 through scan electrode SCn and data electrode D1 through data electrode Dm. Then, negative wall voltage accumulates on scan electrode SC1 through scan electrode SCn. Positive wall voltage accumulates on data electrode D1 through data electrode Dm and sustain electrode SU1 through sustain electrode SUn. Here, the wall voltage on the electrodes means the voltage generated by the wall charge that are accumulated on dielectric layer 25 covering electrodes 22 and electrodes 23, dielectric layer 33 covering electrodes 32, protective layer 26, phosphor layers 35, or the like.

In the second half of the initializing period, positive voltage Ve1 is applied to sustain electrode SU1 through sustain electrode SUn, and a down-ramp waveform voltage is applied to scan electrode SC1 through scan electrode SCn. Here, the down-ramp waveform voltage gradually falls from voltage Vi3, which is equal to or lower than the breakdown voltage, toward voltage Vi4, which exceeds the breakdown voltage with respect to sustain electrode SU1 through sustain electrode SUn. In this application, a weak initializing discharge occurs between scan electrode SC1 through scan electrode SCn and sustain electrode SU1 through sustain electrode SUn, and between scan electrode SC1 through scan electrode SCn and data electrode D1 through data electrode Dm. This weak discharge reduces the negative wall voltage on scan electrode SC1 through scan electrode SCn and the positive wall voltage on sustain electrode SU1 through sustain electrode SUn, and adjusts the positive wall voltage on data electrode D1 through data electrode Dm to a value appropriate for the address operation. In this manner, the initializing operation is completed.

As the driving voltage waveforms in the initializing period, voltage waveforms only in the second half of the initializing period, as shown in the initializing period of the 2nd SF in FIG. 3, may be applied. In this case, an initializing discharge occurs selectively in the discharge cells having undergone a sustain discharge in the sustain period of the immediately preceding subfield.

In the subsequent address period, voltage Ve2 is applied to sustain electrode SU1 through sustain electrode SUn, and voltage Vc is applied to scan electrode SC1 through scan electrode SCn.

Next, negative scan pulse Va is applied to scan electrode SC1 in the first row, and positive address pulse Vd is applied to data electrode Dk (k being 1 through m) in a discharge cell to be lit in the first row among data electrode D1 through data electrode Dm. At this time, the voltage difference in the intersecting part of data electrode Dk and scan electrode SC1 is obtained by adding the difference in an externally applied voltage (Vd−Va) and the difference between the wall voltage on data electrode Dk and the wall voltage on scan electrode SC1, and thus exceeds the breakdown voltage. Then, an address discharge occurs between data electrode Dk and scan electrode SC1, and between sustain electrode SU1 and scan electrode SC1. Positive wall voltage accumulates on scan electrode SC1, and negative wall voltage accumulates on sustain electrode SU1. Negative wall voltage also accumulates on data electrode Dk.

In this manner, the address operation is performed to cause the address discharge in the discharge cells to be lit in the first row and to accumulate wall voltages on the corresponding electrodes. On the other hand, the voltage in the intersecting parts of data electrode D1 through data electrode Dm applied with no address pulse Vd and scan electrode SC1 does not exceed the breakdown voltage, and thus no address discharge occurs. The above address operation is repeated until the operation reaches scan electrode SCn in the discharge cells in the n-th row, and the address period is completed.

In the subsequent sustain period, in the exemplary embodiment, a sustain pulse having a gradual rising edge is applied to each of scan electrode SC1 through scan electrode SCn and sustain electrode SU1 through sustain electrode SUn, so that a sustain discharge is caused in the discharge cells having undergone the address discharge. The sustain pulses will be detailed later. First, the operation in the sustain period is outlined.

In the sustain period, first, a sustain pulse is applied to scan electrode SC1 through scan electrode SCn, and 0(V) is applied to sustain electrode SU1 through sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs, and thus exceeds the breakdown voltage. Then, a sustain discharge occurs between scan electrode SCi and sustain electrode SUi, and ultraviolet light generated at this time causes phosphor layers 35 to emit light. Negative wall voltage accumulates on scan electrode SCi, and positive wall voltage accumulates on sustain electrodes SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) is applied to scan electrode SC1 through scan electrode SCn, and a sustain pulse is applied to sustain electrode SU1 through sustain electrode SUn. Then, in the discharge cell having undergone the sustain discharge, the voltage difference between sustain electrode SUi and scan electrode SCi exceeds the breakdown voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses corresponding in number to the luminance weight are applied alternately to scan electrode SC1 through scan electrode SCn and sustain electrode SU1 through sustain electrode SUn to cause a potential difference between the electrodes of each display electrode pair. Thereby, the sustain discharge is continued in the discharge cells having undergone the address discharge in the address period.

At the end of the sustain period, a voltage difference in the shape of a so-called narrow pulse is caused between scan electrode SC1 through scan electrode SCn and sustain electrode SU1 through sustain electrode SUn. Thereby, while a positive wall voltage is left on data electrode Dk, the wall voltages on scan electrode SCi and sustain electrode SUi are erased. In this manner, the sustain operation in the sustain period is completed.

The operation in the subsequent subfield is substantially similar to the operation in the first SF, and thus the description thereof is omitted.

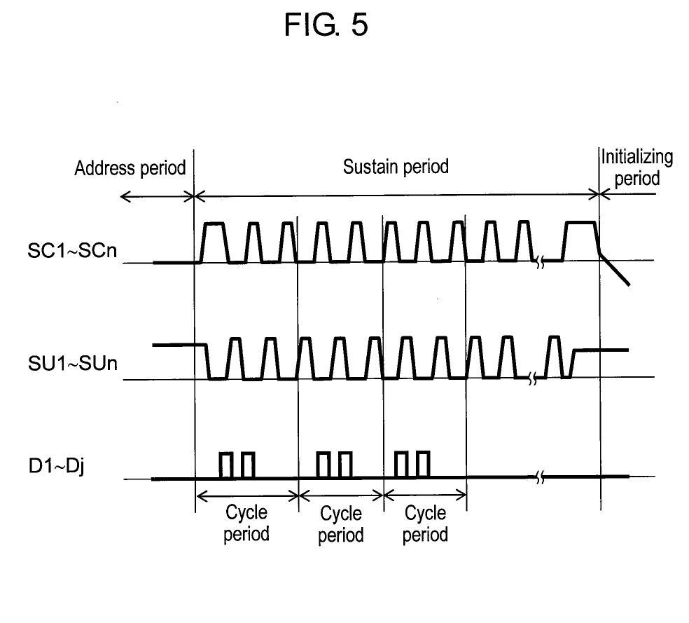

FIG. 5 is a waveform chart of driving voltages applied in a sustain period in plasma display device 1 in accordance with the exemplary embodiment of the present invention. The feature of the driving method for panel 10 of the exemplary embodiment is to control the timing of causing sustain discharges by applying a data voltage to data electrode Di in synchronism with a plurality of sustain pulses applied to scan electrode SCi and sustain electrode SUi in the sustain period, as shown in FIG. 5. That is, driving the panel by applying a data voltage to data electrode Di every successive N (N being an integer equal to or larger than 2) sustain pulses is repeated. The above driving cycle may include a driving state where no data voltage is applied to data electrode Di in synchronism with the plurality of sustain pulses. In the following description, the relation between the sustain pulses and the data voltage to be applied to data electrode Di in the exemplary embodiment is detailed.

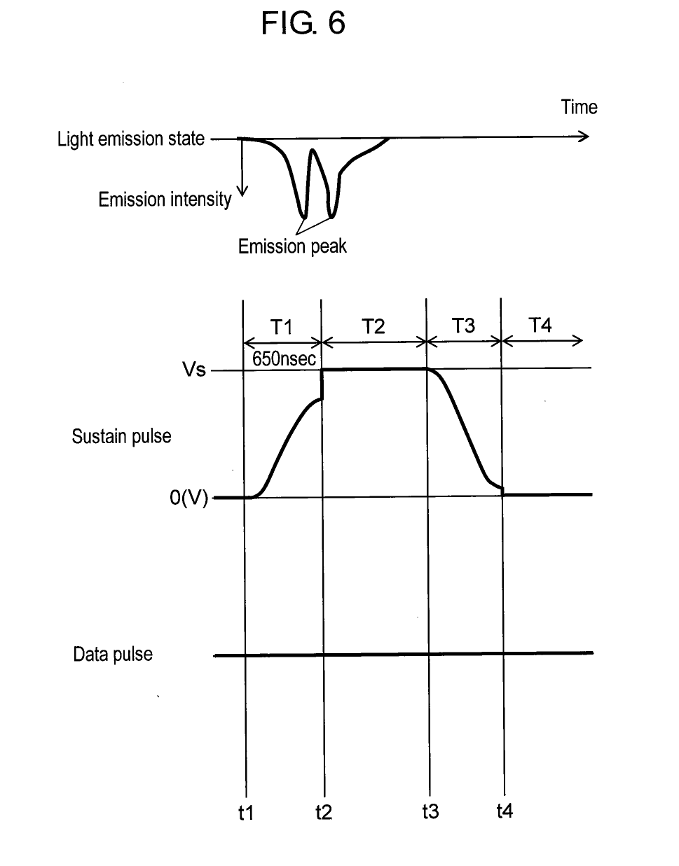

FIG. 6 through FIG. 8 are waveforms for detailing three sustain pulse waveforms used in the exemplary embodiment of the present invention. In each of these waveforms, the horizontal axis represents time. In each chart, the middle waveform shows a voltage waveform (sustain pulse) applied to scan electrodes 22 or sustain electrodes 23 in the sustain period. The bottom waveform shows a voltage waveform (data pulse) applied to data electrodes 32 in the sustain period. The top waveform schematically shows the light emission state in the discharge cell when both of the middle and bottom voltage waveforms are applied. The vertical axis in the top waveform represents emission intensity. That is, the portion projecting downwardly shows the magnitude of light emission caused by a discharge. In the exemplary embodiment, the temporal positions of two strong light emissions are shown. Hereinafter, according to the combination of the sustain pulse and the data pulse, the states in FIG. 6 through FIG. 8 are referred to as a first sustain pulse state, a second sustain pulse state, and a third sustain pulse state for differentiation.

FIG. 6 is a diagram schematically showing the sustain pulse and data pulse and the state of light emission in the first sustain pulse state. As shown by the middle waveform, period T1, i.e. the rising time of the sustain pulse, is 650 nsec. Thereafter, during period T2, the sustain pulse is maintained at voltage Vs as a predetermined voltage. As shown by the bottom waveform, no data pulse is applied to data electrodes 32 in the first sustain pulse state.

As shown by the top waveform, light emission is caused by a discharge in the portions projecting downwardly. This diagram shows a state where two light emissions are caused by strong discharges.

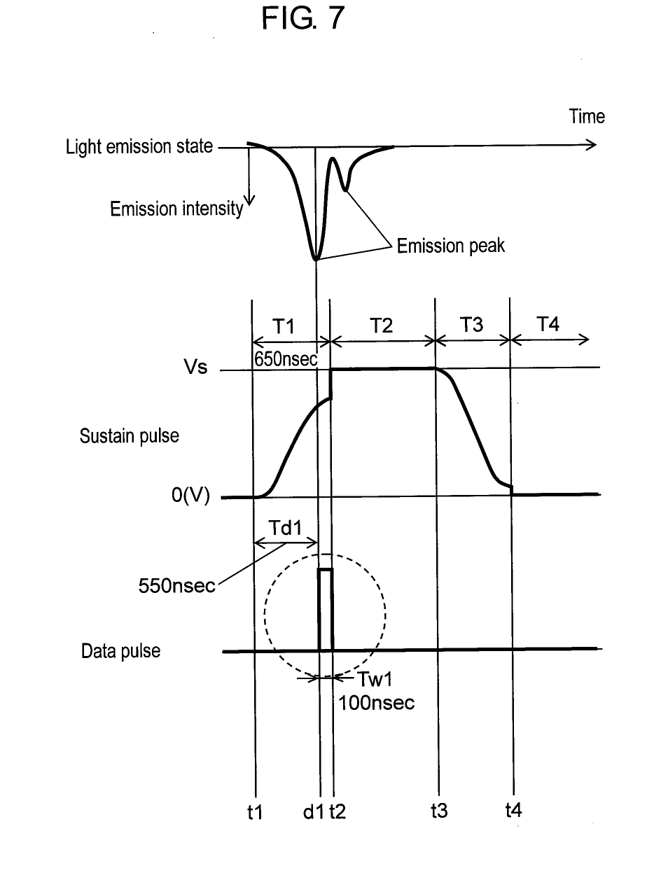

FIG. 7 is a diagram schematically showing the sustain pulse and data pulse and the state of light emission in the second sustain pulse state. Similarly to the first sustain pulse state, period T1, i.e. the rising time of the sustain pulse in the second sustain pulse state, is 650 nsec. Thereafter, during period T2, the sustain pulse is maintained at voltage Vs as the predetermined voltage. However, this pulse state is different from the first sustain pulse state in that, at time d1 550 nsec after the rising timing of the sustain pulse, i.e. a first predetermined timing, a data pulse having a pulse width Tw1 (100 nsec) is applied to data electrodes 32. That is, as shown in FIG. 7, time d1, i.e. the first predetermined timing, is included in period T1, i.e. the rising time of the sustain pulse.

Similarly to FIG. 6, also in FIG. 7, light emission is caused by a discharge in the portions projecting downwardly, as shown by the top waveform.

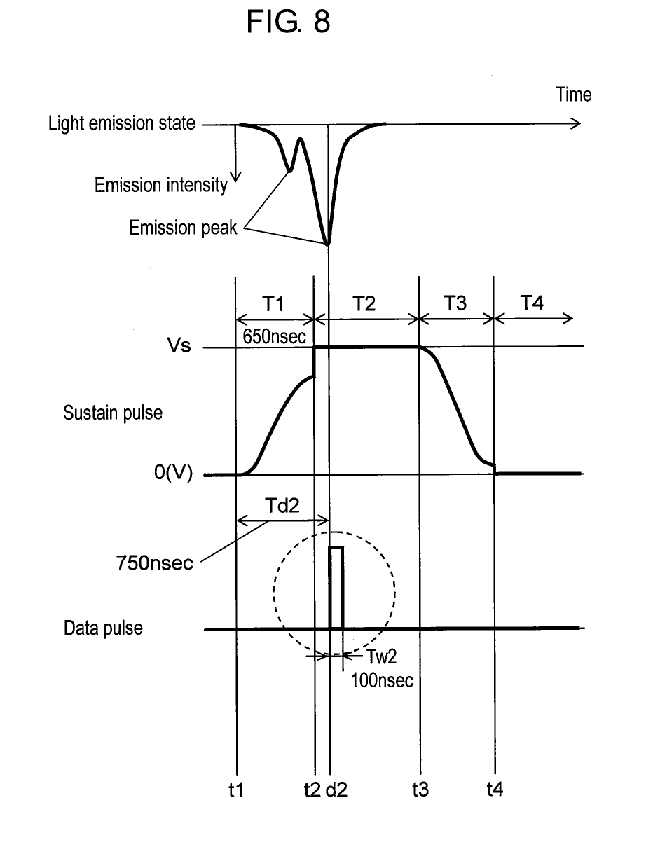

FIG. 8 is a diagram schematically showing the sustain pulse and data pulse and the state of light emission in the third sustain pulse state. Similarly to the first sustain pulse state, period T1, i.e. the rising time of the sustain pulse in the third sustain pulse state, is 650 nsec. Thereafter, during period T2, the sustain pulse is maintained at voltage Vs as the predetermined voltage. However, this pulse state is different from the first sustain pulse state in that, at time d2 750 nsec after the rising timing of the sustain pulse, i.e. a second predetermined timing, a data pulse having a pulse width Tw2 (100 nsec) is applied to data electrodes 32. That is, as shown in FIG. 8, time d2, i.e. the second predetermined timing, is included in period T2 during which the sustain pulse is maintained at voltage Vs as the predetermined voltage.

Similarly to FIG. 6, also in FIG. 8, light emission is caused by a discharge in the portions projecting downwardly, as shown by the top waveform.

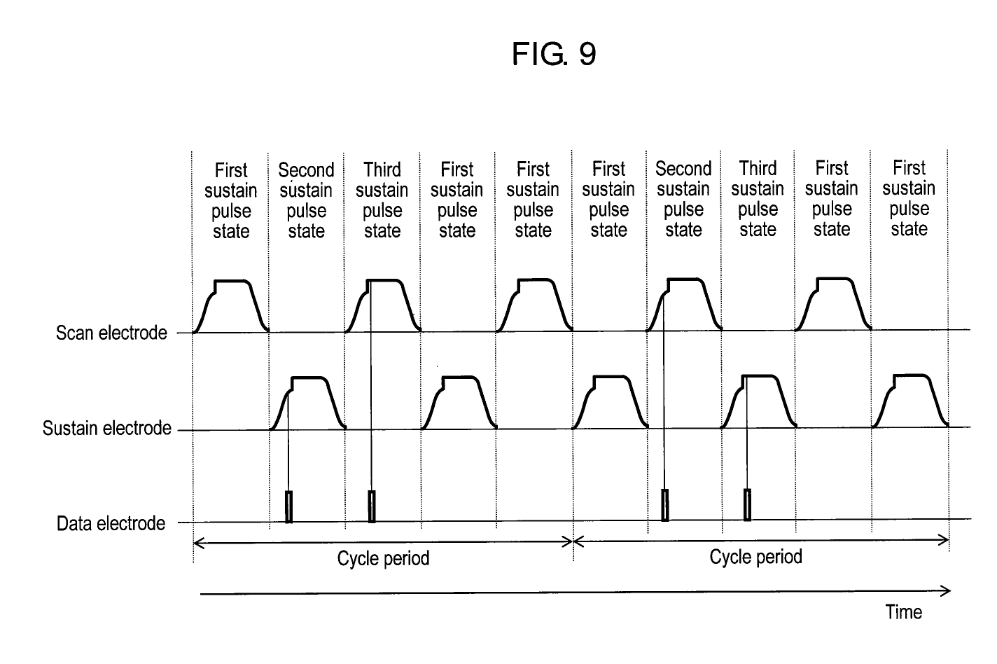

FIG. 9 is a driving waveform chart showing a temporal arrangement of the states where voltages are applied to scan electrodes 22, sustain electrodes 23, and data electrodes 32 in accordance with the exemplary embodiment of the present invention. In this case, the electrodes are driven in a manner such that the first sustain pulse state, the second sustain pulse state, and the third sustain pulse state are arranged in this order. One cycle period is formed of additional two successive first pulse states arranged after the third sustain pulse state. It is shown that scan electrodes 22, sustain electrodes 23, and data electrodes 32 are driven in such a cycle.

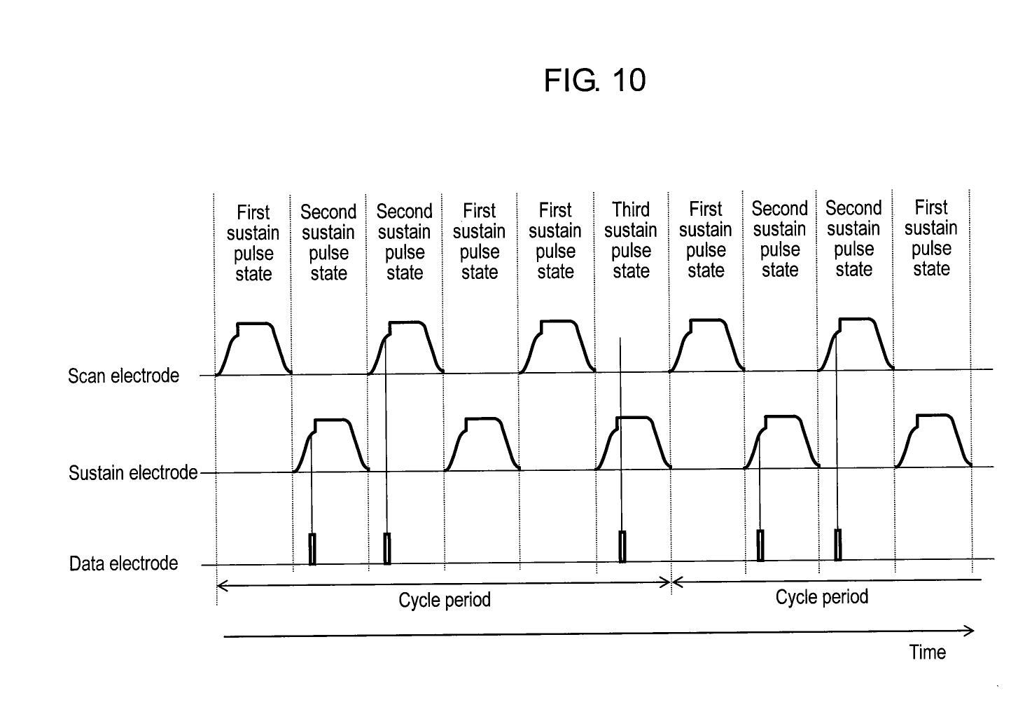

FIG. 10 is a driving waveform chart showing another example of a temporal arrangement of the states where voltages are applied to scan electrodes 22, sustain electrodes 23, and data electrodes 32 in accordance with another exemplary embodiment of the present invention. In this case, one cycle period is formed of the first sustain pulse state, the second sustain pulse state, the second sustain pulse state, the first sustain pulse state, the first sustain pulse state, and the third sustain pulse state arranged in this order. Scan electrodes 22, sustain electrodes 23, and data electrodes 32 are driven in such a cycle.

As described above, plasma display device 1 of the exemplary embodiment causes at least two discharges having different magnitudes in the discharge cells by driving the electrodes in the sustain period of at least one of the subfields in the following manner. Scan electrode driving circuit 53 and sustain electrode driving circuit 54 apply a plurality of sustain pulses alternately to scan electrodes 22 and sustain electrodes 23, and data electrode driving circuit 52 applies a data pulse to data electrodes 32 by changing the timing according to the sustain pulses while the sustain pulses are applied.

Data electrode driving circuit 52 of the exemplary embodiment applies a data pulse to data electrodes 32 while sustain pulses are applied to scan electrodes 22 or sustain electrodes 23. In the sustain period, at least two types of sustain pulse with application of data pulses at difference timings, and a sustain pulse without application of data pulse may be arranged.

A phenomenon of persistence of vision is caused by a change in the emission intensity of a discharge cell depending on the history of the light emission of the discharge cell. For example, an afterimage is recognized in the following case: after a lit discharge cell and an unlit discharge cell have maintained the states for a certain period of time by displaying a still image for an extended period time, for example, the entire screen is lit. When the emission intensity of the lit discharge cell is higher than the emission intensity of the unlit discharge cell, a positive afterimage occurs. In the opposite case, a negative afterimage occurs. Further, when the still image is displayed for a longer time, such an afterimage tends to be stronger.

The inventors have experimentally verified that the phenomenon of persistence of vision can be reduced by controlling the arrangement of the combinations of sustain pulses and data pulses and the rising timings of the data pulses, using the driving method for panel 10 of the exemplary embodiment. Then, the inventors have found that it is preferable to set the positions of the sustain pulses and data pulses optimum depending on the occurrence of the positive or negative afterimage and the strength thereof. Specifically, it is found that the phenomenon of persistence of vision itself is reduced and the display luminance of the respective discharge cells can be made uniform by causing sustain discharges in combination of the following three sustain pulse states: the first sustain pulse state where no data pulse is applied to data electrodes 32; the second sustain pulse state where a discharge is caused at a timing earlier than the rising time of the sustain pulse; and the third sustain pulse state where a discharge is caused at a timing later than the rising timing of the sustain pulse.

Further, according to the light-emitting rate of each subfield, the arrangement of sustain pulses of FIG. 9 and the arrangement of sustain pulses of FIG. 10 may be switched for driving the electrodes. For example, at a high light-emitting rate, a discharge tends to be caused later than the rising timing of a sustain pulse. Thus the number of second sustain pulse states can be increased in the arrangement to cause the discharge earlier. At a low light-emitting rate, the number of third sustain pulse states can be increased in the arrangement to cause the discharge later.

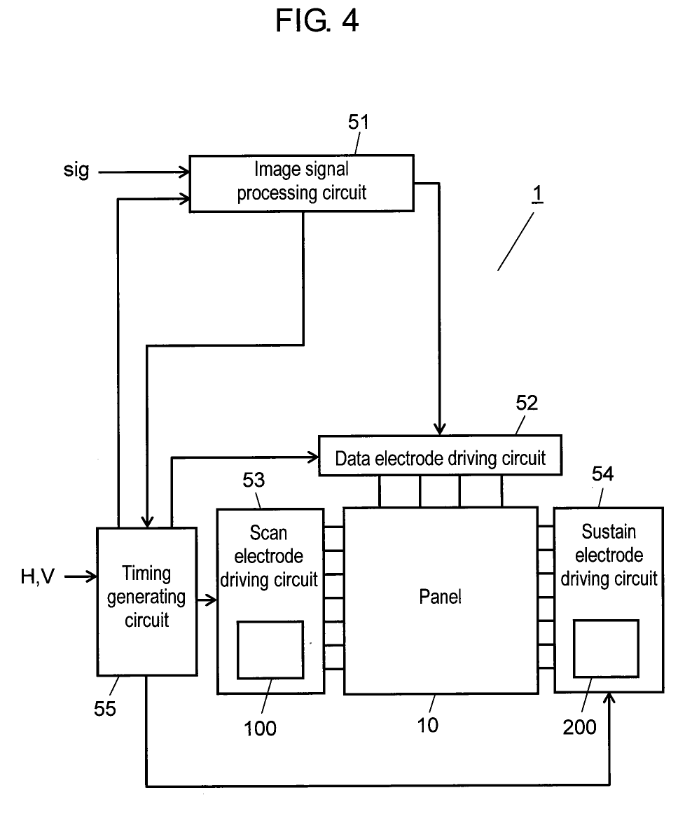

Next, a description is provided for driving circuits for driving panel 10 and the operation thereof. FIG. 4 is a circuit block diagram of plasma display device 1 that includes panel 10 in accordance with the exemplary embodiment of the present invention. Plasma display device 1 has panel 10, image signal processing circuit 51, data electrode driving circuit 52, scan electrode driving circuit 53, sustain electrode driving circuit 54, timing generating circuit 55, and power supply circuits (not shown) for supplying necessary power to each circuit block.

Image signal processing circuit 51 converts input image signal sig into image data showing light emission and no light emission in each subfield. Data electrode driving circuit 52 converts the image data in each subfield into signals corresponding to each of data electrode D1 through data electrode Dm, and drives each of data electrode D1 through data electrode Dm.

Timing generating circuit 55 generates various timing signals for controlling the operation of each circuit block according to horizontal synchronizing signal H and vertical synchronizing signal V, and supplies the timing signals to each circuit block. Scan electrode driving circuit 53 has sustain pulse generating circuit 100 for generating sustain pulses to be applied to scan electrode SC1 through scan electrode SCn in sustain periods, and drives each of scan electrode SC1 through scan electrode SCn according to the timing signals. Sustain electrode driving circuit 54 has sustain pulse generating circuit 200 for generating sustain pulses to be applied to sustain electrode SU1 through sustain electrode SUn in sustain periods, and drives sustain electrode SU1 through sustain electrode SUn according to the timing signals.

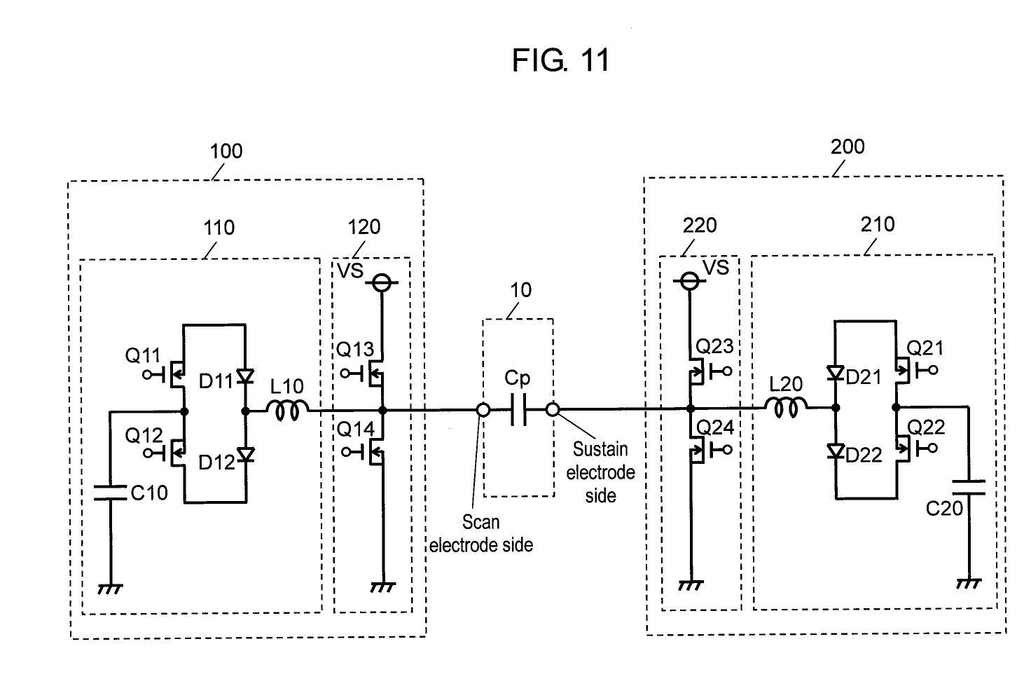

Next, a description is provided for the details and operation of sustain pulse generating circuit 100 and sustain pulse generating circuit 200. FIG. 11 is a circuit diagram of sustain pulse generating circuit 100 and sustain pulse generating circuit 200 in accordance with the exemplary embodiment of the present invention. In FIG. 11, the interelectrode capacitance of panel 10 is shown as Cp, and the circuits for generating scan pulses and initializing voltage waveforms are omitted.

Sustain pulse generating circuit 100 has power recovery circuit 110 and clamp circuit 120. Power recovery circuit 110 has power recovery capacitor C10, switching element Q11, switching element Q12, blocking diode D11, blocking diode D12, and resonance inductor L10. Clamp circuit 120 has switching element Q13 for clamping scan electrodes 22 to power supply VS having a voltage of Vs, and switching element Q14 for clamping scan electrodes 22 to the ground potential. Power recovery circuit 110 and clamp circuit 120 are coupled to scan electrodes 22, i.e. one end of interelectrode capacitance Cp of panel 10, through a scan pulse generating circuit (not shown because the circuit is short-circuited in the sustain periods).

Power recovery circuit 110 causes LC resonance between interelectrode capacitance Cp and inductor L10 to make a sustain pulse rise and fall. In the rising time of a sustain pulse, the electric charge stored in power recovery capacitor C10 is moved to interelectrode capacitance Cp through switching element Q11, diode D11, and inductor L10. In the falling time of the sustain pulse, the electric charge stored in interelectrode capacitance Cp of panel 10 is returned to power recovery capacitor C10 through inductor L10, diode D12, and switching element Q12. In this manner, sustain pulses are applied to scan electrodes 22.

Power recovery circuit 110 thus drives scan electrodes 22, using LC resonance, and thereby reduces power consumption. Power recovery capacitor C10 has a capacitance sufficiently larger than interelectrode capacitance Cp, works as a power supply of power recovery circuit 110, and is charged to approximately Vs/2, i.e. a half of voltage Vs of power supply VS.

Clamp circuit 120 allows scan electrodes 22 to be coupled to power supply VS through switching element Q13 and clamped to voltage Vs. Further, the clamp circuit allows scan electrodes 22 to be grounded through switching element Q14 and clamped to 0 (V). Clamp circuit 120 thus drives scan electrodes 22. For this reason, the impedance during voltage application of clamp circuit 120 is small and thus a large discharge current can be supplied by a strong sustain discharge in a stable manner.

In this manner, in sustain pulse generating circuit 100, switching element Q11, switching element Q12, switching element Q13, and switching element Q14 are controlled so that sustain pulses are applied t o scan electrodes 22 using power recovery circuit 110 and clamp circuit 120. These switching elements can be formed of generally known devices, such as a metal-oxide-semiconductor field-effect transistor (MOSFET) and an insulated gate bipolar transistor (IGBT).

Sustain pulse generating circuit 200 has power recovery circuit 210 and clamp circuit 220. The power recovery circuit has power recovery capacitor C20, switching element Q21, switching element Q22, blocking diode D21, blocking diode D22, and resonance inductor L20. The clamp circuit has switching element Q23 for clamping sustain electrodes 23 to voltage Vs, and switching element Q24 for clamping sustain electrodes 23 to the ground potential. The sustain pulse generating circuit is coupled to sustain electrodes 23, i.e. one end of interelectrode capacitance Cp of panel 10. The operation of sustain pulse generating circuit 200 is similar to that of sustain pulse generating circuit 100, and the description thereof is omitted. The period of LC resonance between inductor L10 of power recovery circuit 110 and interelectrode capacitance Cp of panel 10, and the period of LC resonance (hereinafter referred to as “resonance period”) between inductor L20 of power recovery circuit 210 and interelectrode capacitance Cp of the panel can be obtained by the formula “2π√(LCp)” where the inductance of each of inductor L10 and inductor L20 is L. In the exemplary embodiment, inductor L10 and inductor L20 are set so that the resonance periods in power recovery circuit 110 and power recovery circuit 210 are each approximately 1,600 nsec.

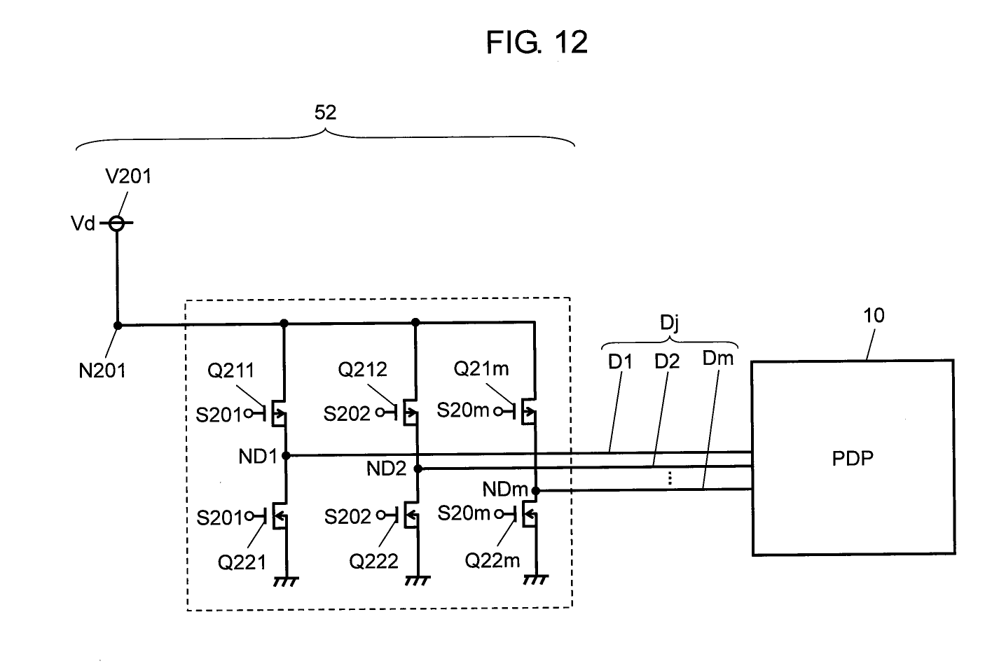

Next, the data electrode driving circuit is described. FIG. 12 is a circuit diagram showing an example of a configuration of data electrode driving circuit 52 of FIG. 4.

Data electrode driving circuit 52 of FIG. 12 has a plurality of p-channel FETs (each being a field-effect transistor, hereinafter simply referred to as a transistor) Q211 through Q21m, and a plurality of n-channel FETs (each being a field-effect transistor, hereinafter simply referred to as a transistor) Q221 through Q22m. Power supply terminal V201 is connected to node N201. Voltage Vd is applied to power supply terminal V201.

Transistor Q211 through transistor Q21m are connected between node N201 and node ND1 through node NDm, respectively. Transistor Q221 through transistor Q22m are connected between node ND1 through NDm and the ground terminals. Node ND1 through node NDm are connected to corresponding data electrode D1 through data electrode Dm of FIG. 2.

Control signal S201 through control signal S20m are input to the gates of the plurality of transistor Q211 through transistor Q21m, respectively. Control signal S201 through control signal S20m are also input to the gates of transistor Q221 through transistor Q22m, respectively. The above control signal S201 through control signal S20m are input, as timing signals, to data electrode driving circuit 52 from timing generating circuit 55 of FIG. 4.

Next, the operation of the sustain pulse generating circuit and the data pulse generating circuit is described with reference to FIG. 6 through FIG. 8. Herein, the description is provided for sustain pulse generating circuit 100 on the side of scan electrodes 22. Sustain pulse generating circuit 200 on the side of sustain electrodes 23 has a similar circuit structure and performs substantially similar operation.

First, the first sustain pulse state of FIG. 6 is described.

(Period T1)

In order to generate a sustain pulse in period T1, i.e. the rising time of the sustain pulse, switching element Q11 is turned on at time t1. Then, electric charge starts to move from power recovery capacitor C10 to scan electrodes 22 through switching element Q11, diode D11, and inductor L10, so that the voltage of scan electrodes 22 starts to rise. Then, in the discharge cells having undergone an address discharge in the address period, the voltage difference between scan electrodes 22 and sustain electrodes 23 exceeds the breakdown voltage. Thereby, a sustain discharge occurs and the first light emission occurs. With this discharge, the voltage of scan electrodes 22 starts to fall rapidly and the voltage difference between scan electrodes 22 and sustain electrodes 23 temporarily becomes lower than the breakdown voltage. Next, at the time before approximately a half of the resonance period has elapsed since time t1, switching element Q13 is turned on. Then, scan electrodes 22 are coupled to power supply VS through switching element Q13, and thus clamped to voltage Vs at time t2.

(Period T2)

When scan electrodes 22 are clamped to voltage Vs in period T2 during which the sustain pulse is maintained at voltage Vs as a predetermined voltage, the voltage difference between scan electrodes 22 and sustain electrodes 23 in the discharge cells having undergone the address discharge in the address period exceeds the breakdown voltage again. Thereby, a sustaining discharge occurs and the second light emission occurs. In this manner, in the first sustain pulse state, at least two strong light emissions are measured.

As described above, in the exemplary embodiment, a half of the period of resonance between inductor L10 and interelectrode capacitance Cp is set to approximately 800 nsec. The rising time of the sustain pulse applied to scan electrodes 22, i.e. period T1 from time t1 to time t2, is set to approximately 650 nsec.

(Period T3)

In order to generate the first sustain pulse in period T3, switching element Q12 is turned on at time t3. Electric charge starts to move from scan electrodes 22 to capacitor C10 through inductor L10, diode D12, and switching element Q12, so that the voltage of scan electrodes 22 starts to fall. Because inductor L10 and interelectrode capacitance Cp form a resonance circuit, at the time when approximately a half of the resonance period has elapsed since time t3, the voltage of scan electrodes 22 falls to the vicinity of 0 (V). Thereafter, switching element Q14 is turned on. Then, scan electrodes 22 are directly grounded through switching element Q14, and thus clamped to voltage 0 (V) at time t4. That is, period T3 is the falling time of the sustain pulse.

(Period T4)

Next, in order to generate the first sustain pulse in period T4, scan electrodes 22 are kept clamped to 0 (V) from time t4. That is, period T4 is a period during which the sustain pulse is maintained at 0 (V).

In this manner, in the first sustain pulse state, period T1, i.e. the rising time of the sustain pulse, is approximately 650 nsec, which is set shorter than approximately 800 nsec, i.e. a half of the period of resonance between inductor L10 and interelectrode capacitance Cp. Then, in the first sustain pulse state, two sustain discharges occur, and at least two large light emissions are observed.

Next, the second sustain pulse state of FIG. 7 is described.

(Period T1)

In order to generate a sustain pulse in period T1, i.e. the rising time of the sustain pulse, switching element Q11 is turned on at time t1. Then, electric charge starts to move from power recovery capacitor C10 to scan electrodes 22 through switching element Q11, diode D11, and inductor L10, so that the voltage of scan electrodes 22 starts to rise. Because inductor L10 and interelectrode capacitance Cp form a resonance circuit, at the time before a half of the resonance period has elapsed since time t1, the voltage of scan electrodes 22 rises to the vicinity of Vs. At a first predetermined timing, i.e. time d1, data electrode driving circuit 52 applies a data pulse to data electrodes 32. In this example, period Td1 from time t1 to time d1 is 550 nsec. Pulse width Tw1 of the data pulse is 100 nsec, for example.

Applying the data pulse in this manner forces the voltage difference between scan electrodes 22 and sustain electrodes 23 in the discharge cells having undergone an address discharge in the address period to exceed the breakdown voltage. Thereby, the first sustain discharge starts and the first light emission occurs. The light emission at this time is influenced by the discharge caused by application of the data pulse, and is stronger than the first light emission of the first sustain pulse. With this discharge, the voltage of scan electrodes 22 starts to fall rapidly and the voltage difference between scan electrodes 22 and sustain electrodes 23 temporarily becomes lower than the breakdown voltage. Thereafter, at the time before a half of the resonance period has elapsed since time t1, switching element Q13 is turned on. Then, scan electrodes 22 are coupled to power supply VS through switching element Q13, and thus clamped to voltage Vs at time t2.

In the exemplary embodiment, time d1 before scan electrodes 22 are clamped to voltage Vs is set to the first predetermined timing. However, similarly, time d1 before sustain electrodes 23 are clamped to voltage Vs is also the first predetermined timing.

In this example, period Td1 from time t1 to time d1, i.e. the first predetermined timing, is set to 550 nsec. However, period Td1 is not necessarily limited to this value, and varies with the design conditions for panel 10. In terms of reducing the phenomenon of persistence of vision, and making the display luminance of each discharge cell uniform, an optimum value can be easily selected.

(Period T2)

When scan electrodes 22 are clamped to voltage Vs in period T2 during which the sustain pulse is maintained at voltage Vs as the predetermined voltage, the second sustain discharge occurs and the second light emission occurs in the discharge cells where the first sustain discharge has started.

The operation in period T3 and period T4 is similar to that in the first sustain pulse state, and the description of that operation is omitted.

In this manner, in the second sustain pulse state, the sustain pulse and the data pulse cause two sustain discharges, and at least two large light emissions are observed. However, the first light emission is caused with the application of the data pulse, and thus the first light emission is strong and the second light emission is relatively weaker than the first light emission caused with the application of the data pulse. That is, data electrode driving circuit 52 of the exemplary embodiment applies the data pulse to data electrodes 32 at the timing such that the light emission of the first discharge is stronger than the light emission of the second discharge.

Next, the third sustain pulse state of FIG. 8 is described.

(Period T1)

In order to generate a sustain pulse in period T1, i.e. the rising time of the sustain pulse, switching element Q11 is turned on at time t1. Then, electric charge starts to move from power recovery capacitor C10 to scan electrodes 22 through switching element Q11, diode D11, and inductor L10, so that the voltage of scan electrodes 22 starts to rise. Because inductor L10 and interelectrode capacitance Cp form a resonance circuit, at the time before a half of the resonance period has elapsed since time t1, the voltage of scan electrodes 22 rises to the vicinity of Vs. Then, in the discharge cells having undergone an address discharge in the address period, the voltage difference between scan electrodes 22 and sustain electrodes 23 exceeds the breakdown voltage. Thereby, a sustain discharge occurs and the first light emission occurs. With this discharge, the voltage of scan electrodes 22 starts to fall rapidly and the voltage difference between scan electrodes 22 and sustain electrodes 23 temporarily becomes lower than the breakdown voltage. Thereafter, at the time before a half of the resonance period elapses since time t1, switching element Q13 is turned on. Then, scan electrodes 22 are coupled to power supply VS through switching element Q13, and thus clamped to voltage Vs at time t2.

(Period T2)

When scan electrodes 22 are clamped to voltage Vs in period T2 during which the sustain pulse is maintained at voltage Vs as the predetermined voltage, the second sustain discharge occurs and the second light emission occurs in the discharge cells where the first sustain discharge has started. Here, at a second predetermined timing after scan electrodes 22 have been clamped to voltage Vs, i.e. time d2, data electrode driving circuit 52 applies a data pulse to data electrodes 32. In this example, period Td2 from time t1 to time d2 is 750 nsec. Pulse width Tw2 of the data pulse is 100 nsec, for example. With the application of the data pulse in this manner, the second light emission is influenced by the discharge caused by the data pulse, and is relatively stronger than the second discharge of the first sustain pulse. That is, data electrode driving circuit 52 of the exemplary embodiment applies the data pulse to data electrodes 32 at the timing such that the light emission of the second discharge is stronger than the light emission of the first discharge.

In the exemplary embodiment, time d2 after scan electrodes 22 have been clamped to voltage Vs is set to the second predetermined timing. However, similarly, time d2 after sustain electrodes 23 have been clamped to voltage Vs is also the second predetermined timing.

As for the second predetermined timing, i.e. time d2, in this example, period Td2 from time t1 to time d2 is set to 750 nsec. However, period Td2 is not necessarily limited to this value, and varies with the design conditions for panel 10. In terms of reducing the phenomenon of persistence of vision, and making the display luminance of each discharge cell uniform, an optimum value can be easily selected.

Again, the operation in period T3 and period T4 is similar to that in the first sustain pulse state, and the description of that operation is omitted.

In this manner, in the third sustain pulse state, the sustain pulse and the data pulse cause two sustain discharges, and at least two large light emissions are observed. However, because the second light emission is caused with the application of the data pulse, the second light emission is strong, and the first light emission is relatively weaker than the second light emission caused with the application of the data pulse.

As described above, in the exemplary embodiment, the timing at which data electrode driving circuit 52 applies the data pulses to data electrodes 32 is before or after the timing at which sustain pulses applied to scan electrodes 22 or sustain electrodes 23 are clamped to voltage Vs as the predetermined voltage. In this manner, this operation can reduce the phenomenon of persistence of vision itself and make the display luminance of each discharge cell uniform.

In the examples of the exemplary embodiment, as shown in FIG. 9 and FIG. 10, three states, i.e. the first sustain pulse state, the second sustain pulse state, and the third sustain pulse state, are switched and arranged. However, the exemplary embodiment is not limited to these examples. For example, scan electrodes 22, sustain electrodes 23, and data electrodes 32 may be driven with pulses arranged in the following order: the first sustain pulse state; the third sustain pulse state; the third sustain pulse state; the first sustain pulse state; the first sustain pulse state; and the second sustain pulse state. In this manner, the arrangement order of the first sustain pulse state, the second sustain pulse state, the third sustain pulse state is not limited to the above combinations.

In the description of the exemplary embodiment, the pulses are generated so that the three states, i.e. the first sustain pulse state, the second sustain pulse state, and the third sustain pulse state, are switched. However, in the present invention, two types of pulse state, e.g. the first sustain pulse state and the second sustain pulse state, and the second sustain pulse state and the third sustain pulse state, may be combined and arranged. The present invention is not necessarily limited to the combination of three types of state.

In the combination of two types of state as described above, it is preferable to cause the two states with the same degree of probability in terms of reducing the phenomenon of persistence of vision itself and making the display luminance of each discharge cell uniform. Further, when pulses are generated so that the three states, i.e. the first sustain pulse state, the second sustain pulse state, and the third sustain pulse state, are switched, it is preferable to cause the three states with the same degree of probability also in terms of reducing the power consumption.

In the description of the exemplary embodiment, one filed is divided into ten subfields (the first SF, and the second SF through the tenth subfield), and the respective subfields have luminance weights of 1, 2, 3, 6, 11, 18, 30, 44, 60 and 81. However, in the present invention, the number of subfields and the luminance weights of the respective subfields are not limited to the above values.

In the description of the exemplary embodiment, an all-cell initializing operation is performed in the initializing period of the first SF, and a selective initializing operation is performed in the initializing period of the second SF. However, the present invention is not limited to this structure, and the all-cell initializing operation or selective initializing operation may be performed optionally in each subfield.

In the description of the exemplary embodiment, the same inductor is used for power supply and power recovery. However, the present invention is not limited to this structure. A structure using different inductors for power supply and power recovery, e.g. a structure having separate power supply path and power recovery path, may be used.

In the exemplary embodiment, the xenon partial pressure of the discharge gas is set to 10%. However, other xenon partial pressures may be used. In such a case, the driving voltage is set to a value appropriate for the panel.

In the description of the exemplary embodiment, pulse width Tw1 and pulse width Tw2 of the data pulses to be applied to data electrodes 32 in the second sustain pulse state and the third sustain pulse state are set to the same value of 100 nsec. However, these pulse widths may be set to different values. That is, pulse width Tw1 and pulse width Tw2 of the data pulses to be applied to data electrodes 32 by data electrode driving circuit 52 may be different according to the timing from the application of the sustain pulse. Pulse width Tw1 may be set from approximately 50 nsec to 1000 sec, for example. Pulse width Tw2 may be set from 50 nsec to the time period until time t3, for example.

The specific values used in the exemplary embodiment are only examples. It is preferable to set values optimum for the characteristics of the panel and the specifications of the plasma display device for each case.

### INDUSTRIAL APPLICABILITY

The present invention is useful as a plasma display device and driving method for a panel that provide high-fidelity image display with high image display quality, reduce the phenomenon of persistence of vision itself, and consume less power.

### REFERENCE SIGNS LIST

1 Plasma display device

10 Panel

21 Front plate

22 Scan electrode

23 Sustain electrode

24 Display electrode pair

25, 33 Dielectric layer

26 Protective layer

31 Rear plate

32 Data electrode

34 Barrier rib

35 Phosphor layer

51 Image signal processing circuit

52 Data electrode driving circuit

53 Scan electrode driving circuit

54 Sustain electrode driving circuit

55 Timing generating circuit

100, 200 Sustain pulse generating circuit

110, 210 Power recovery circuit

120, 220 Clamp circuit

Tw1 Pulse width

Tw2 Pulse width

1. A plasma display device comprising:
a plasma display panel including:
a first substrate having display electrode pairs in a parallel direction, each of the display electrode pairs being formed of a scan electrode and a sustain electrode; and
a second substrate having data electrodes in a vertical direction,
the first substrate and the second substrate being disposed so that discharge cells are formed in intersecting parts of the display electrode pairs and the data electrodes;
a scan electrode driving circuit for driving the scan electrodes;
a sustain electrode driving circuit for driving the sustain electrodes; and
a data electrode driving circuit for driving the data electrodes,
the plasma display panel being driven by a subfield method where one field is formed of a plurality of subfields,
wherein, in a sustain period of at least one of the subfields,
the scan electrode driving circuit and the sustain electrode driving circuit apply a plurality of sustain pulses alternately to the scan electrodes and the sustain electrodes, and
the data electrode driving circuit applies a data pulse to the data electrodes by changing a timing according to the sustain pulses while the sustain pulses are applied.

2. The plasma display device of claim 1,
wherein the data electrode driving circuit applies the data pulse to the data electrodes at the timing such that a light emission of a first discharge is stronger than a light emission of a second discharge.

3. The plasma display device of claim 1,
wherein the data electrode driving circuit applies the data pulse to the data electrodes at the timing such that a light emission of a second discharge is stronger than a light emission of a first discharge.

4. The plasma display device of claim 1,
wherein the timings at which the data electrode driving circuit applies the data pulse to the data electrodes are a first predetermined timing and a second predetermined timing.

5. The plasma display device of claim 1,
wherein the timing at which the data electrode driving circuit applies the data pulse to the data electrodes is before or after a timing at which the sustain pulses applied to the scan electrodes or the sustain electrodes are clamped to a predetermined voltage.

6. A driving method for a plasma display device, the plasma display device including:
a plasma display panel including:
a first substrate having display electrode pairs in a parallel direction, each of the display electrode pairs being formed of a scan electrode and a sustain electrode; and
a second substrate having data electrodes in a vertical direction,
the first substrate and the second substrate being disposed so that discharge cells are formed in intersecting parts of the display electrode pairs and the data electrodes;
a scan electrode driving circuit for driving the scan electrodes;
a sustain electrode driving circuit for driving the sustain electrodes; and
a data electrode driving circuit for driving the data electrodes,
the plasma display panel being driven by a subfield method where one field is formed of a plurality of subfields,
the method comprising:
in a sustain period of at least one of the subfields,
applying sustain pulses alternately to the scan electrodes and the sustain electrodes using the scan electrode driving circuit and the sustain electrode driving circuit; and
applying a data pulse to the data electrodes using the data electrode driving circuit by changing a timing while the sustain pulses are applied.
